(19) United States
(12) Patent Application Publication
(10) Pub. No.: US 2015/0112771 A1
(43) Pub. Date: Apr. 23, 2015

(54) SYSTEMS, METHODS, AND PROGRAM PRODUCTS FOR ENHANCING PERFORMANCE OF AN ENTERPRISE COMPUTER SYSTEM

(71) Applicant: Blue Slate Solutions, LLC, Albany, NY (US)

(72) Inventor: David Scott Read, Scotia, NY (US)

(21) Appl. No.: 14/517,474

(22) Filed: Oct. 17, 2014

Related U.S. Application Data
(60) Provisional application No. 61/892,573, filed on Oct. 18, 2013.

(51) Int. Cl. G06Q 10/06; G06F 17/30

(52) U.S. Cl. CPC G06Q 10/0639; G06F 17/30598
USPC 705/7.38

(57) ABSTRACT

An enterprise analysis system method and program product. A system is disclosed having: a system for overlaying a cognitive framework onto an existing organizational structure of an enterprise to identify both operational and behavioral data; a system for characterizing the operational and behavioral data within an ontology that provides a semantic naming convention; and a system for analyzing the integration of operational and behavioral data to identify patterns.

### RELATED APPLICATION

This application claims priority to U.S. Ser. No. 61/892,573, filed on Oct. 18, 2013, the content of which is incorporated by reference as if fully set forth herein.

### FIELD

The present application generally relates to systems, methods and program products for analyzing and/or enhancing performance for enterprise computer systems. In embodiments, the present invention systematically provides improvements to rules and workflows employed in enterprise computer systems.

### SUMMARY

The present application generally relates to systems, methods and program products for analyzing and/or enhancing performance for enterprise computer systems. In embodiments, the present invention systematically provides improvements to rules and workflows employed in enterprise computer systems.

In embodiments a computer-implemented system, method and/or program product is disclosed for enterprise analysis. An enterprise analysis system may begin an enterprise analysis process by associating, using one or more computers, a plurality of component data comprising component information of an enterprise system with respective category data comprising category information of a cognitive analysis framework, the category information comprising: (a) a user activity category information associated with user interactions in the enterprise system; (b) a communication category information associated with communications produced by the enterprise system; (c) an action category information associated with actions taken by the enterprise system; (d) a knowledge category information associated with data stored by the enterprise system; (e) a sensory category information associated with external interfaces of the enterprise system; and (f) a learning category information associated with feedback analytics of the enterprise system. In embodiments, not all of the above categories may be used and/or other categories may be added. Next, the enterprise analysis system may store, by the one or more computers, the associated respective category data for each of the plurality of component data. The enterprise analysis system may assign, using the one or more computers, a respective weight value for each of the plurality of component data. The enterprise analysis system may store, by the one or more computers, a first ontology comprising workflow definitions (as discussed further herein). The enterprise analysis system may also store, by the one or more computers, a second ontology comprising business rule definitions. The enterprise analysis system may store, by the one or more computers, a third ontology comprising operational data definitions. The enterprise analysis system may obtain (e.g., receive and/or fetch), by the one or more computers, runtime behavioral data comprising performed workflow data specified in the first ontology and implicated business rule data specified in the second ontology, and point-in-time operational data associated with a runtime behavior of the enterprise system and associated with a timestamp and specified in the third ontology. The enterprise analysis system may obtain by the one or more computers, resultant operational data specified in the third ontology. The enterprise analysis system may analyze, using the one or more computers, the runtime behavioral data, the point-in-time operational data, the resultant operational data, and the respective weight values to determine one or more first data patterns associated with a first event. The enterprise analysis system may determine, using the one or more computers, one or more modified behavioral data records calculated to modify a recurrence of the first event. The enterprise analysis system may generate, by the one or more computers, an electronic report identifying the one or more modified behavioral data records. The electronic report may comprise one or more inputs into a feedback process, calculated to improve performance of the process.

In embodiments, the enterprise system can include health care data. In embodiments, the enterprise system can include insurance data.

In embodiments, the first event may relate to the occurrence of a productivity inefficiency. In embodiments, the first event may relate to an insurance claim rejection.

In embodiments, the electronic report may be transmitted to a user electronic device. In embodiments, the electronic report may comprise an input into a simulation module. In embodiments, the electronic report may comprise an input into a project management module. In embodiments, the enterprise analysis system may provide the electronic report as an input to a feedback loop of the enterprise system.

In embodiments, the one or more modified behavioral data records may relate to modification of one or more workflows. In embodiments, the one or more modified behavioral data records may relate to modification of one or more business rules. In embodiments, the one or more modified behavioral data records may be calculated, by the one or more computers, to improve performance of the enterprise system. In embodiments, the modified behavioral data records may comprise a modified value of a data record, which may be stored as a new data record.

In embodiments, the enterprise analysis system may generate, by the one or more computers, a second electronic report comprising an assessment of the performance of the system, wherein the assessment may be based at least in part upon the respective weight values and the runtime behavioral data. In embodiments, the assessment may comprise an actualization score indicating a value associated with potential performance by the enterprise system. In embodiments, the assessment may comprise an actualization score for each respective category information indicating a value associated with potential performance by the enterprise system associated with the respective category information.

In embodiments, the enterprise analysis system may integrate the runtime behavioral data and the operational data using a semantic data integration model.

In embodiments, obtaining runtime behavioral data comprising performed workflow data specified in the first ontology may further comprise obtaining, by the one or more computers, the performed workflow data; specifying, using the one or more computers, the performed workflow data in the first ontology; and/or storing, by the one or more computers, the performed workflow data specified in the first ontology.

In embodiments, obtaining runtime behavioral data comprising implicated business rule data specified in the second ontology may further comprise obtaining, by the one or more computers, the implicated business rule data; specifying, using the one or more computers, the implicated business rule data in the second ontology; and/or storing, by the one or more computers, the implicated business rule data specified in the second ontology.

In embodiments, obtaining point-in-time operational data associated with a runtime behavior of the enterprise system and associated with a timestamp and specified in the third ontology may further comprise obtaining, by the one or more computers, the point-in-time operational data; specifying, using the one or more computers, the point-in-time operational data in the third ontology; and/or storing, by the one or more computers, the point-in-time operational data specified in the third ontology.

In embodiments, obtaining resultant operational data specified in the third ontology may further comprise obtaining, by the one or more computers, the resultant operational data; specifying, using the one or more computers, the resultant operational data in the third ontology; and/or storing, by the one or more computers, the resultant operational data specified in the third ontology.

### BRIEF DESCRIPTION OF THE DRAWINGS

These and other features of this invention will be more readily understood from the following detailed description of the various aspects of the invention taken in conjunction with the accompanying drawings.

FIG. 1A is a schematic diagram of an exemplary system for enterprise performance analysis in accordance with exemplary embodiments of the present invention;

FIG. 1B is a schematic diagram of an exemplary performance analysis computer system in accordance with exemplary embodiments of the present invention;

FIG. 1C is a schematic diagram of an exemplary enterprise system in accordance with exemplary embodiments of the present invention;

FIG. 2 is a schematic diagram of category data for a cognitive analysis and associated data flows in accordance with exemplary embodiments of the present invention;

FIGS. 3A-B are flow charts showing exemplary processes for enterprise analysis in accordance with exemplary embodiments of the present invention;

FIG. 4 depicts an exemplary database architecture for cognitive analysis and actualization analysis in accordance with exemplary embodiments of the present invention;

FIG. 5A is a schematic diagram of an exemplary enterprise system in accordance with exemplary embodiments of the present invention;

FIG. 5B is an exemplary portion of a database storing identified enterprise system components in accordance with exemplary embodiments of the present invention;

FIG. 5C is a schematic diagram of an exemplary enterprise system with associated cognitive analysis category data in accordance with exemplary embodiments of the present invention;

FIG. 5D is an exemplary portion of a database storing category data for enterprise system components in accordance with exemplary embodiments of the present invention;

FIG. 5E is an exemplary portion of a database storing scoring data for enterprise system components in accordance with exemplary embodiments of the present invention;

FIG. 5F is an exemplary portion of a database storing actualization data for cognitive analysis categories of an enterprise system in accordance with exemplary embodiments of the present invention; and

FIG. 6 is a schematic diagram illustrating exemplary implementation of behavioral and operational analytics in accordance with exemplary embodiments of the present invention.

The drawings are merely schematic representations, not intended to portray specific parameters of the invention. The drawings are intended to depict only typical embodiments of the invention, and therefore should not be considered as limiting the scope of the invention. In the drawings, like reference numbering represents like elements.

### DETAILED DESCRIPTION

The present application generally relates to systems, methods and program products for analyzing and/or enhancing performance for enterprise computer systems. In embodiments, the present invention systematically provides improvements to rules and workflows employed in enterprise computer systems.

In embodiments a computer-implemented system, method and/or program product is disclosed for enterprise analysis. An enterprise analysis system may begin an enterprise analysis process by associating, using one or more computers, a plurality of component data comprising component information of an enterprise system with respective category data comprising category information of a cognitive analysis framework, the category information comprising: (a) a user activity category information associated with user interactions in the enterprise system; (b) a communication category information associated with communications produced by the enterprise system; (c) an action category information associated with actions taken by the enterprise system; (d) a knowledge category information associated with data stored by the enterprise system; (e) a sensory category information associated with external interfaces of the enterprise system; and (f) a learning category information associated with feedback analytics of the enterprise system. In embodiments, not all of the above categories may be used and/or other categories may be added. Next, the enterprise analysis system may store, by the one or more computers, the associated respective category data for each of the plurality of component data. The enterprise analysis system may assign, using the one or more computers, a respective weight value for each of the plurality of component data. The enterprise analysis system may store, by the one or more computers, a first ontology comprising workflow definitions (as discussed further herein). The enterprise analysis system may also store, by the one or more computers, a second ontology comprising business rule definitions. The enterprise analysis system may store, by the one or more computers, a third ontology comprising operational data definitions. The enterprise analysis system may obtain (e.g., receive and/or fetch), by the one or more computers, runtime behavioral data comprising performed workflow data specified in the first ontology and implicated business rule data specified in the second ontology, and point-in-time operational data associated with a runtime behavior of the enterprise system and associated with a timestamp and specified in the third ontology. The enterprise analysis system may obtain by the one or more computers, resultant operational data specified in the third ontology. The enterprise analysis system may analyze, using the one or more computers, the runtime behavioral data, the point-in-time operational data, the resultant operational data, and the respective weight values to determine one or more first data patterns associated with a first event. The enterprise analysis system may determine, using the one or more computers, one or more modified behavioral data records calculated to modify a recurrence of the first event. The enterprise analysis system may generate, by the one or more computers, an electronic report identifying the one or more modified behavioral data records. The electronic report may comprise one or more inputs into a feedback process, calculated to improve performance of the process.

In embodiments, the enterprise system can include health care data. In embodiments, the enterprise system can include insurance data.

In embodiments, the first event may relate to the occurrence of a productivity inefficiency. In embodiments, the first event may relate to an insurance claim rejection.

In embodiments, the electronic report may be transmitted to a user electronic device. In embodiments, the electronic report may comprise an input into a simulation module. In embodiments, the electronic report may comprise an input into a project management module. In embodiments, the enterprise analysis system may provide the electronic report as an input to a feedback loop of the enterprise system.

In embodiments, the one or more modified behavioral data records may relate to modification of one or more workflows. In embodiments, the one or more modified behavioral data records may relate to modification of one or more business rules. In embodiments, the one or more modified behavioral data records may be calculated, by the one or more computers, to improve performance of the enterprise system. In embodiments, the modified behavioral data records may comprise a modified value of a data record, which may be stored as a new data record.

In embodiments, the enterprise analysis system may generate, by the one or more computers, a second electronic report comprising an assessment of the performance of the system, wherein the assessment may be based at least in part upon the respective weight values and the runtime behavioral data. In embodiments, the assessment may comprise an actualization score indicating a value associated with potential performance by the enterprise system. In embodiments, the assessment may comprise an actualization score for each respective category information indicating a value associated with potential performance by the enterprise system associated with the respective category information.

In embodiments, the enterprise analysis system may integrate the runtime behavioral data and the operational data using a semantic data integration model.

In embodiments, obtaining runtime behavioral data comprising performed workflow data specified in the first ontology may further comprise obtaining, by the one or more computers, the performed workflow data; specifying, using the one or more computers, the performed workflow data in the first ontology; and/or storing, by the one or more computers, the performed workflow data specified in the first ontology.

In embodiments, obtaining runtime behavioral data comprising implicated business rule data specified in the second ontology may further comprise obtaining, by the one or more computers, the implicated business rule data; specifying, using the one or more computers, the implicated business rule data in the second ontology; and/or storing, by the one or more computers, the implicated business rule data specified in the second ontology.

In embodiments, obtaining point-in-time operational data associated with a runtime behavior of the enterprise system and associated with a timestamp and specified in the third ontology may further comprise obtaining, by the one or more computers, the point-in-time operational data; specifying, using the one or more computers, the point-in-time operational data in the third ontology; and/or storing, by the one or more computers, the point-in-time operational data specified in the third ontology.

In embodiments, obtaining resultant operational data specified in the third ontology may further comprise obtaining, by the one or more computers, the resultant operational data; specifying, using the one or more computers, the resultant operational data in the third ontology; and/or storing, by the one or more computers, the resultant operational data specified in the third ontology.

Exemplary embodiments of the present invention are discussed with reference to the figures.

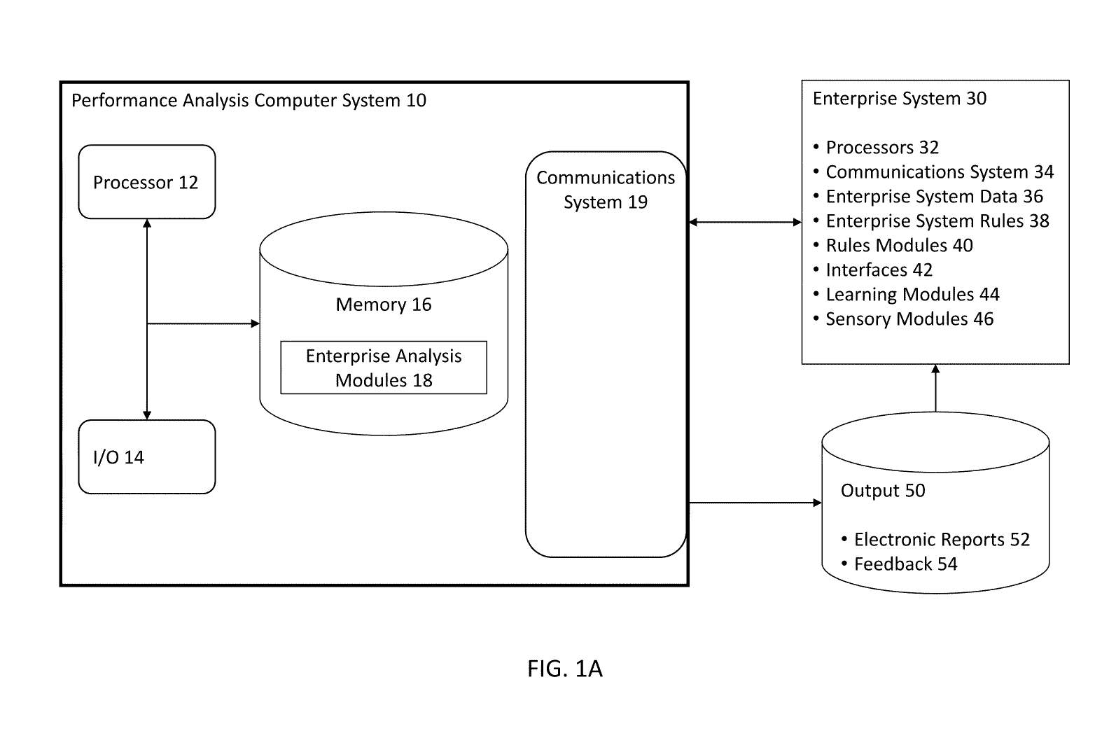

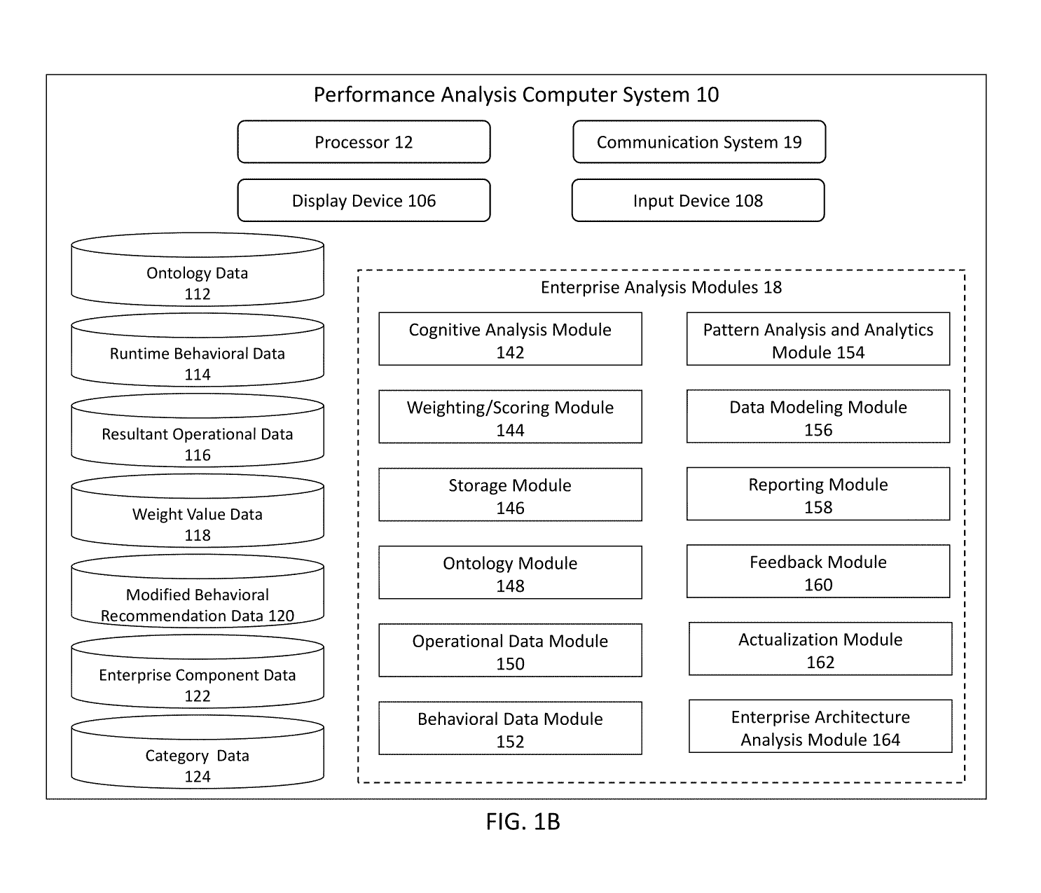

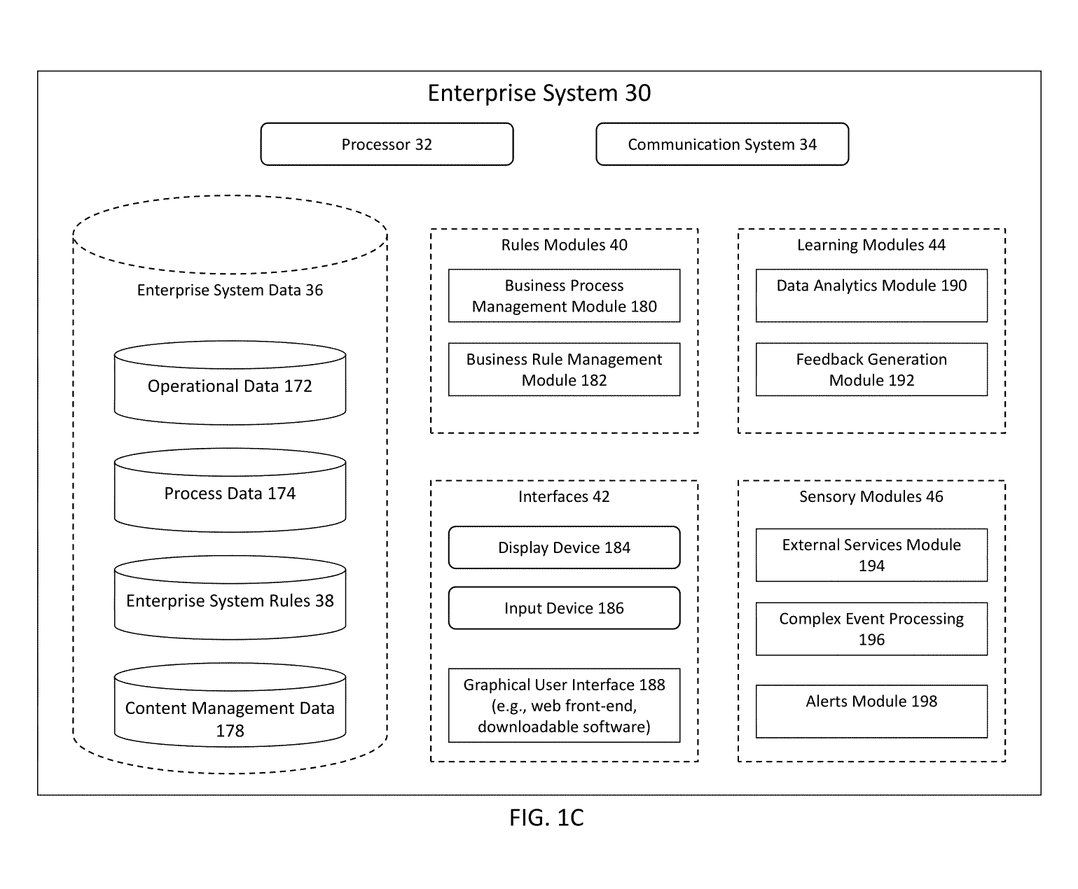

FIG. 1A depicts a performance analysis computer system 10 for analyzing and improving the performance of an enterprise system 30. The performance analysis computer system 10 can include one or more computers each comprising one or more processors 12. The computer system 10 may also have one or more input/output devices 14 operatively connected to the one or more processors 12. For example, it may have one or more input devices such as keyboards, touch screens, mice, and/or scanners operatively connected to text recognition software, to name a few, and/or it may have one or more output devices, such as display screens, speakers, and/or printing devices.

The computer system 10 may include computer-readable memory 16 operatively connected to the one or more processors 12. Memory 16 may be internal to the computer system 10 and/or external and may comprise one or more hard drives, disk drives and disks, tape drives and tapes, and/or flash memory storage devices, to name a few. One or more enterprise analysis modules 18 may be stored in memory 16 and may run or be configured to run on the one or more processors 12. The enterprise analysis modules 18 may perform and/or facilitate performance of processes to analyze performance of an enterprise system 30.

The computer system 10 can also include one or more communications systems 19, which may handle, process, support, and/or perform wired and/or wireless communications. Communications systems can comprise hardware (e.g., hardware for wired and/or wireless connections) and/or software. In embodiments, communications systems can include one or more communications chipsets, such as a GSM chipset, CDMA chipset, LTE chipset, Wi-Fi chipset, Bluetooth chipset, to name a few, and/or combinations thereof. Wired connections may be adapted for use with cable, plain old telephone service (POTS) (telephone), fiber (such as Hybrid Fiber Coaxial), xDSL, to name a few, and wired connections may use coaxial cable, fiber, copper wire (such as twisted pair copper wire), and/or combinations thereof, to name a few. Wired connections may be provided through telephone ports, Ethernet ports, USB ports, and/or other data ports, such as Apple 30-pin connector ports or Apple Lightning connector ports, to name a few. Wireless connections may include cellular or cellular data connections and protocols (e.g., digital cellular, PCS, CDPD, GPRS, EDGE, CDMA2000, 1xRTT, Ev-DO, HSPA, UMTS, 3G, 4G, and/or LTE, to name a few), Bluetooth, Bluetooth Low Energy, Wi-Fi, radio, satellite, infrared connections, ZigBee communication protocols, to name a few. Communications interface hardware and/or software, which may be used to communicate over wired and/or wireless connections, may comprise Ethernet interfaces (e.g., supporting a TCP/IP stack), X.25 interfaces, T1 interfaces, and/or antennas, to name a few.

The computer system 10 may communicate, e.g., through the one or more communications systems 19, with an enterprise computer system 30. The computer system 10 may communicate directly and/or indirectly, e.g., through a data network, such as the Internet, a telephone network, a mobile broadband network (such as a cellular data network), a mesh network, Wi-Fi, WAP, LAN, and/or WAN, to name a few. Accordingly, computer system 10 may obtain and/or receive data from the enterprise system 30.

Enterprise system 30 may be a computer system, e.g., a computer system for a business or other organization, comprising one or more processors 32, a communications system 34, enterprise system rules 38, interfaces 42, and/or enterprise system data 36. Enterprise system data 36 may be data identifying and/or describing components, structures, relationships, processes, outcomes, and/or business rules, to name a few. For example, enterprise system data 36 can include operational data (e.g., name and address of customers), behavioral data (e.g., what type of customers bought what type of products), and/or rules and processes (e.g., workflows), to name a few. The enterprise system 30 can further include interfaces 42 (e.g., web pages for collecting data) and/or one or more modules, such as rules modules 40, learning modules 44, and/or sensory modules 46, to name a few. Enterprise systems are described herein with respect to FIG. 1C.

Still referring to FIG. 1A, a performance analysis computer system 10 can generate one or more outputs 50. Outputs 50 may include electronic reports 52. In embodiments, outputs 50 can include feedback 54, which may be input back into the enterprise system 30 and/or into a simulation module (e.g., for simulating performance effects of proposed feedback on the enterprise system 30) or a project management module.

FIG. 1B is a schematic diagram of another embodiment of an exemplary performance analysis computer system 10. The computer system 10 may comprise hardware, such as one or more processors 102, communication systems 104, display devices 106 (e.g., display screens, projectors), and/or input devices 108 (e.g., keyboard, mouse, touch screen, microphone, scanner, camera, to name a few). The computer system 10 may include one or more database stored on non-transitory computer-readable memory. Databases can include ontology data 112, runtime behavioral data 114, resultant operational data 116, weigh value data 118, modified behavioral recommendation data 120, enterprise system component data 122, and/or category data 124, as described herein. In embodiments, any of the data described herein may be stored in the same or different databases, on memory internal or external to the computer system 10. The computer system 10 may also include one or more software modules stored on the non-transitory computer-readable memory and running or configured to run on the one or more processors 102. Accordingly, the computer system 10 can include a cognitive analysis module 142, a weighting/scoring module 144, a storage module 146, an ontology module 148, an operational data module 150, a behavioral data module 152, a pattern analysis and analytics module 154, a data modeling module 156, a reporting module 158, a feedback module 160, an actualization module 162, and/or an enterprise architecture analysis module 164, as described herein. In embodiments, any of the processes attributed to these modules may be performed by one or more other modules.

A performance analysis computer system 10 may obtain (e.g., access from an enterprise computer system and/or receive from an enterprise computer system) enterprise system data. The computer system 10 may store the enterprise system data in computer-readable memory. The data may describe one or more components, processes, inputs, outputs, rules, and/or statuses of the enterprise system. The data can include static process definitions, static business rule definitions, runtime behavioral data 114, and resultant operational data 116. Runtime behavioral data 114 may comprise data identifying workflows or processes that were actually performed, steps of processes that were performed, decision points that were reached, operational values at runtime, and/or business rules (e.g., programmable logical business rules) that were implicated. Meanwhile, resultant operational data 116 may identify end results of one or more processes, outputs, and/or decisions that were made. Operational data 116 may also include inputs to the enterprise system. An operational data module 150 may handle the obtaining of operational data 116, while a behavioral data module 152 may handle the obtaining of behavioral data 114, which may be obtained during execution of business processes or following completion of one or more processes. Automated logging may be used to collect operational and/or behavioral data. For example, one or more electronic logs of process steps, decisions, data values, and/or outcomes may be generated and/or transmitted to the computer system 10.

The performance analysis computer system may perform semantic-based data management, which can allow information to be shared among enterprise system components. In a typical environment, the enterprise will tell each component “where” to find the data they need, i.e., “location based integration”. For example, it may tell a business process management (“BPM”) tool to reach into a database to pull a data field. However, the BPM tool would not know what it is pulling since it does not know the meaning of the extracted data. In order to address this gap, the present invention applies meaning to all the data in the enterprise using semantically based data integration. The semantic-based data management can allow components to pull data based on knowing its meaning instead of knowing its physical location. For example, if the BPM tool needs to display a First Name, it can ask the database system for a First Name instead of asking for the item in column 3 of table 5.

A set of tools may provide machine interpretation of the data instead of human interpretation. Information may be federated across systems, and the meaning of the data may stay the same as the data moves around. One approach for implementing semantic based data management includes providing an ontology that describes the data.

An ontology module 148 can implement semantic-based data management using one or more ontologies. An ontology may be a domain-specific classification of entities and their relationships to one another. In embodiments, an ontology can be applied to a semantic dataset in conjunction with a reasoner to yield additional information and relationships that were not explicit in the original dataset. In other words, a system making use of one or more ontologies may be able to infer relationships between data that were previously hidden, aiding with categorization, knowledge extraction, and pattern recognition.

For instance, an exemplary enterprise system that manages health care claims could characterize operational and behavioral data with terms and hierarchies relevant to industry, e.g., operational data could be stored as follows:

```
<Patient>
  <Patient.Name>=
  <Patient.DOB>=
  <Patient.history.1>=
    <Patient.history.1.1>=
    <Patient.history.1.2>=
  <Patient.history.2>=
And behavioral data could be stored as:
<Claim>
  <Claim.type> =
  <Claim Date entered> =
  < action taken.1> =
    <response.1> =
  <action taken.2> =
    <response.2> =
  <claim disposition> =
```

The ontology module 148 may map data to a respective ontology. Accordingly, the ontology module 148 may convert operational data to an operational data ontology and/or convert behavioral data to one or more behavioral data ontologies (e.g., a workflow ontology, a business rule ontology, to name a few). An ontology may comprise a framework for storing data, such as by defining types of data, properties of the data, and/or relationships among the data. Different ontologies (e.g., semantic-based ontologies) may be used for different types of data, although the ontologies may enable integration of the different data types for analysis. For example, workflow data may be converted to and specified in a workflow data ontology, and/or business rule data may be converted to and specified in a business rule ontology. A storage module 146 may be used to organize and/or store the enterprise system data, including data that is specified in a respective ontology. The computer system 10 may store ontology data 112 for specifying the ontology schemas, which may comprise ontology definitions.

A weighting/scoring module 144 may be used to assign measures of relative importance to components of an enterprise system. For example, each component may be assigned a weight. In embodiments, each type of component (e.g., human interaction components) may be assigned a weight instead of or in addition to each component individually. That weight value data 118 can then be used, as an input or a constraint, in one or more performance analyses of the enterprise system (e.g., an actualization analysis, an enterprise architecture improvement analysis, and/or a performance improvement analysis, as described herein).

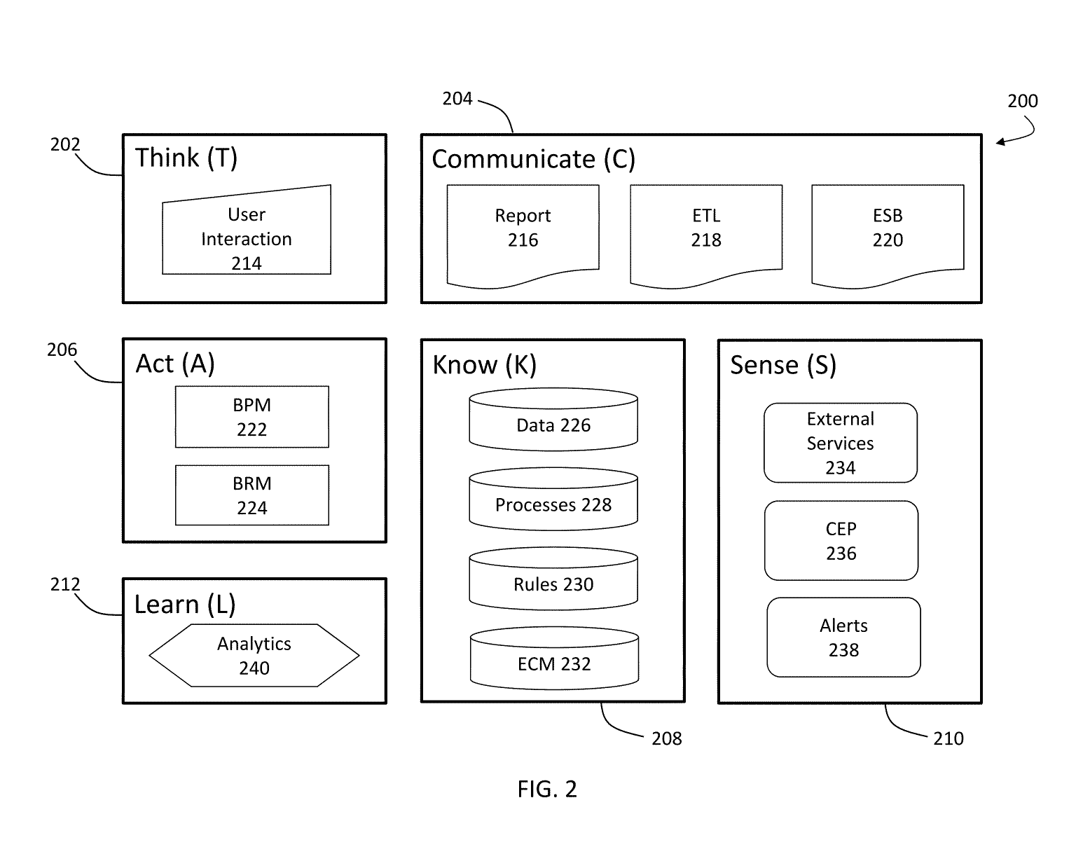

A cognitive analysis module 142 may be used to identify, for one or more components of the enterprise system, associated categories corresponding to a cognitive analysis framework. In embodiments, the cognitive analysis module 142 may first identify one or more enterprise system components and store corresponding enterprise system component data 122 that identifies the enterprise components. For example, enterprise system component data 122 identifying an enterprise system component, such as a particular user interface, may be stored along with framework category data 124 identifying a “think” category, which may be a category for user activity. Category data 124 is described herein with respect to FIG. 2. The component data 122 and the category data 124 may be stored in one or more databases. The category data 124 may be stored along with enterprise system component data 122 (such as in a database field indicating one or more categories associated with the enterprise system components). In embodiments, the component data 122 and category data 124 may be stored in the same database table and/or in separate linked tables. In other embodiments, non-relational database architectures may be employed for associating analysis framework category data 124 with enterprise system component data 122. In embodiments, semantic-based data management may be employed, as described herein.

One or more modules may be used to perform various analyses of the enterprise system. A pattern analysis and analytics module 154 may determine patterns or data trends. For example, it may recognize repeated occurrences (e.g., a denial of an insurance claim) and/or may identify circumstances (e.g., workflow steps, process inputs, decisions) that led to the occurrences. The pattern analysis and analytics module 154 may determine recommendations for modifying behavioral data to alter (e.g., improve) performance of the enterprise system. The results may be stored as modified behavioral recommendation data 120 and/or may be output in an electronic report or as feedback to the enterprise system or to a simulation program.

A data modeling module 156 may generate one or more data models based upon the enterprise data. The models may integrate the enterprise behavioral and operational data, which integration may be facilitated using semantic-based ontologies for each data type. The data models may describe the enterprise system and may enable simulations of future performance and/or simulations of performance with changed parameters (e.g., modified behavioral data). In embodiments, iterative simulations may be used to determine recommended modifications to behavioral data.

An actualization module 162 may be used to analyze whether the enterprise system is performing at its potential (e.g., in terms of capacity and/or efficiency). The actualization module may use the enterprise component data 122, the weight value data 118, and/or the category data 124 to determine one or more potential performance levels for the enterprise system. For example, potential performance levels may be determined for each category. In embodiments, the actualization module 162 may be used to determine the degree to which the one or more potential performance levels are realized by the enterprise system. Accordingly, the actualization module 162 may determine category actualization scores indicating the degree of actualization (e.g., fulfillment of potential) of the enterprise system with respect to each category.

An enterprise architecture analysis module 164 may be used to determine possible performance enhancements to reach a target performance level. It may produce a future state blueprint, which may be an enterprise architecture (e.g., comprising a plurality of enterprise system components, relationships among components, and/or processes) that describes target performance levels for one or more components or categories of the enterprise system. The future state blueprint may identify and/or recommend possible investments and/or possible improvements (e.g., improvements to current components, processes, and/or outputs) for the enterprise system.

A reporting module 158 may be used to generate one or more types of electronic reports. Such electronic reports can indicate the degree to which the enterprise system 30 is performing at its potential (e.g., in terms of capacity and/or efficiency). Electronic reports can be used to identify areas of improvement to the enterprise system. Electronic reports can identify results of data pattern analysis and/or recommendations for modifying enterprise system parameters. Accordingly, reports may identify components of the enterprise where improvements are possible and/or may determine possible performance enhancements to reach a target performance level.

A feedback module 160 may generate electronic feedback data. Electronic feedback data may be automatically input into one or more processes or systems of the enterprise 30 in order to effectuate changes, directly or indirectly, within enterprise 30. In embodiments, feedback data may be input into a simulation module to determine projected performance, to iteratively determine modifications to achieve performance enhancements, and/or to test recommended modified behavioral data values 120 that are calculated to enhance performance of the enterprise system.

FIG. 1C illustrates an exemplary enterprise system in accordance with exemplary embodiments of the present invention. The enterprise system 30 may comprise a computer system having one or more computers, which may have one or more processors 32. The enterprise system 30 may have non-transitory computer-readable memory and may also have a communications system 34. Exemplary communications systems are described herein with respect to communications system 19 of FIG. 1A. Still referring to FIG. 1C, the enterprise system 30 can include enterprise system data 36, rules modules, interfaces 42, learning modules 44, and/or sensory modules 46, to name a few. The modules may be stored on the memory and configured to run on the one or more processors 32.

Enterprise system data 36 can comprise operational data 172 (e.g., data identifying and/or describing inputs, outputs, system conditions, system statuses, and/or other facts regarding the enterprise system), process data 174 (e.g., data identifying and/or describing workflows or other processes), enterprise system rules 38 (e.g., business process management rules, business rule management definitions, and/or other rules governing one or more operations within an enterprise system), and/or content management data 178 (e.g., data associated with document imaging, data or document content analytics, and/or file organization, to name a few).

Rules modules 40 can include one or more modules for creating, modifying, and/or implementing the enterprise system rules that govern the enterprise system (e.g., rules governing workflow and/or decision points). Enterprise system rules may be programmable business rules. A business process management (“BPM”) module 180 may handle business process management definitions and/or execution for governing business processes. A business rule management (“BRM”) module 182 may handle business rule management definitions and/or execution for governing relationships among enterprise system components and/or relationship with external entities (e.g., customers of an enterprise system). Rules modules 40 can include additional modules such as electronic content management rules for handling the content management data 178.

The enterprise system 30 can include one or more interfaces 42, which may comprise hardware and/or software. Interfaces 42 can include one or more output devices, such as display devices 184, speakers, and/or printers. Interfaces 42 can also include one or more input devices 186, such as keyboards, mice, touch screens, microphones, and/or cameras, to name a few. Input devices and output devices may have corresponding software. A graphical user interface 188 may provide an electronic interface for users to interact with the enterprise system 30. The graphical user interface 188 may be provided through a website (e.g., a web front-end) and/or may be provided through downloadable software (e.g., a mobile application and/or desktop software).

Learning modules 44 can include modules by which the enterprise system may perform analyses and/or simulations. For example, a data analytics module 190 may perform one or more analyses, e.g., related to operations of the enterprise system 30. A feedback generation module 192 may generate feedback within the enterprise system 30 and/or may output feedback to one or more external systems.

Sensory modules 46 may interact with external systems and/or with external entities. An external services module 194 may provide services from the enterprise system 30 to one or more other systems, devices, or entities. In embodiments, the external services module 194 may monitor services (e.g., processes) performed external to the enterprise system 30. A complex event processing module 196 may obtain and/or combine data from multiple sources, which may include data sources external to the enterprise system 30. The complex event processing module 196 may then determine data patterns and/or occurrences of particular events. Such determinations may be performed in real-time as data is obtained (e.g., accessed and/or received). Data patterns and events may be processed to determine conclusions, e.g., regarding decisions to make or additional process steps to perform. An alerts module 198 may provide alerts and/or react to alerts (e.g., by receiving an alert, determining a meaning of the alert, and/or determining an action in response to the alert).

FIG. 2 illustrates category data associated with a cognitive analysis that can be performed by a cognitive analysis module. In embodiments, the categories may comprise a cognitive analysis framework. The exemplary cognitive analysis category map 200 shows how categories can be associated with components of an enterprise system. The illustrated categories include a user activity category 202 (which may be referred to as a think category), a communication category 204, an action category 206, a knowledge category 208, a sensory category 210, and a learning category 212.

The user activity category 202 may apply to user interactions 214, such as user inputs and system outputs to the user via a graphical user interface (e.g., a web user interface and/or a downloadable software user interface). User interfaces may collect and/or display information to users.

The communication category 204 can include system processes such as reporting 216 (e.g., generating and/or transmitting reports), extract transform and load (“ETL”) processes 218 (e.g., processes for obtaining and extracting data from one or more sources, which may be homogeneous or heterogeneous data sources), and/or enterprise service buses (“ESB”) 220 (e.g., architecture for communicating among modules and/or applications in the enterprise system). Communications may be directed to elements of the user activity category 202 (e.g., user interfaces), as well as bi-directionally with one or more databases in the knowledge category 208.

The action category 206 may be associated with rules that govern the enterprise system, such as business process management rules 222 and/or business rule management definitions 224. Such rules may make decisions at various decision points in workflows or other processes and/or may make decisions in response to occurrences of particular events.

The knowledge category 208 may identify storage of data 226 (e.g., data obtained by and/or generated by the enterprise system 30), processes 228 (e.g., workflows), rules 230 (e.g., business process management rules), and/or electronic content management (“ECM”) 232 (e.g., organization of files, version control for files, to name a few).

The sensory category 210 may refer to enterprise system components and/or processes that interface with external systems and/or with external entities. Accordingly, the sensory category 210 may be associated with external services 234, complex event processing 236, and/or alerts 238. Data obtained from sensory components or processes may be stored by the enterprise system, e.g., in the knowledge category.

The learning category 212 may generally include analytics 240 that can analyze data and rules. Such analytics 240 may provide feedback for improving the enterprise system.

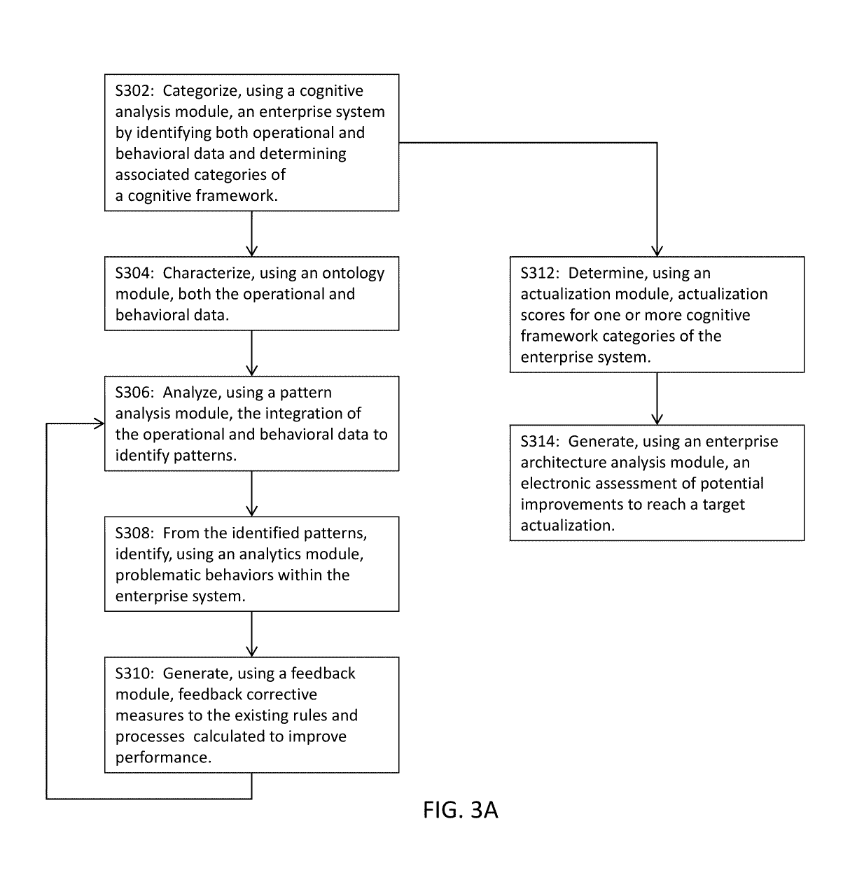

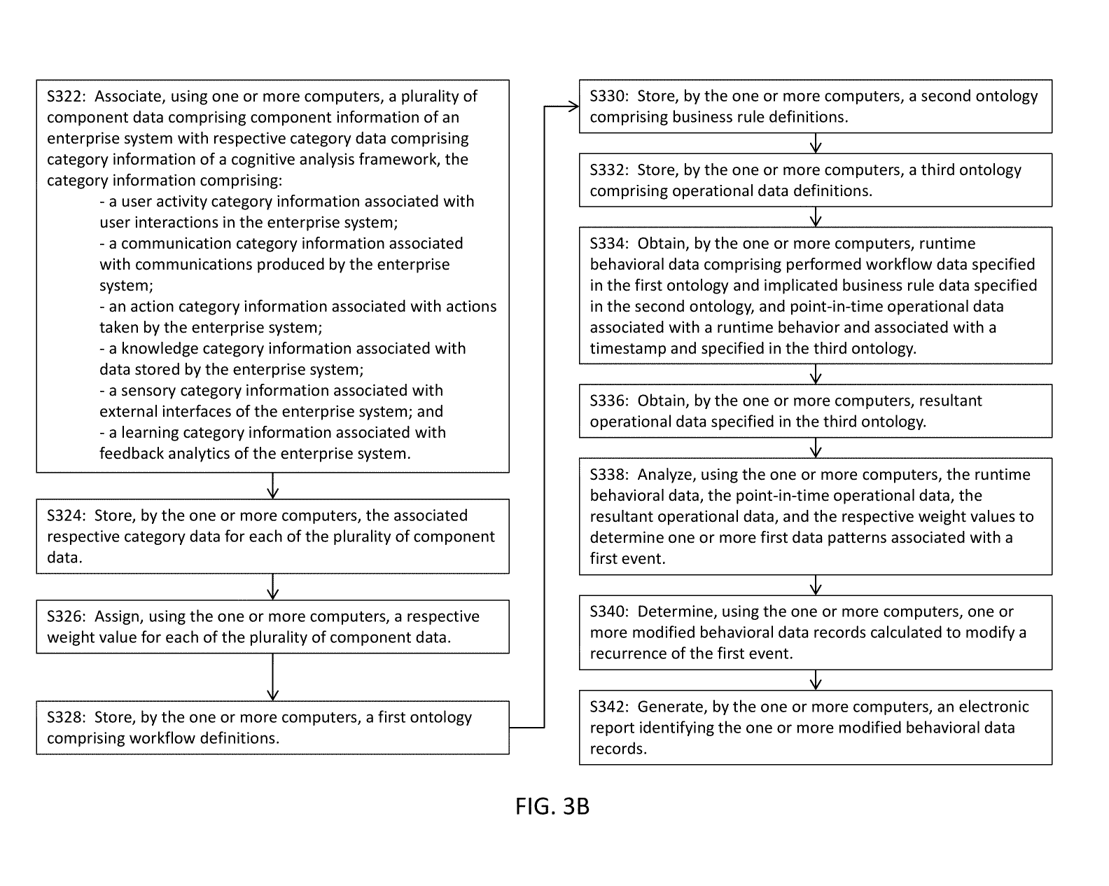

Referring now to FIG. 3A, a flow chart of an exemplary process for enterprise analysis is shown. The process may be performed by a performance analysis computer system 10. First, at a step S302, a cognitive analysis module can be used to categorize an enterprise system. Categorizing the enterprise system can comprise identifying components of the enterprise system (e.g., interfaces, operational data, workflow and rule definitions, and/or behavioral data) and/or determining associated categories of a cognitive analysis framework.

At a step S304, an ontology module may be used to characterize the operational and behavioral (e.g., static and/or runtime) data of the enterprise system. Characterizing the data can comprise specifying the data according to one or more ontological schemas (e.g., one or more semantic-based ontological schemas). A semantic naming convention may be used to describe and/or store the enterprise system data.

At a step S306, a pattern analysis module may analyze an integration of the operational and behavioral data to identify patterns in the data. Pattern analysis can comprise first integrating the operational and behavioral data, which may be facilitated by the ontologies used to store each type of data. The integrated data may then be analyzed to identify patterns.

At a step S308, an analytics module may be used to identify problematic behaviors within the enterprise system based upon the identified data patterns. In embodiments, the analytics module may be part of a pattern analysis and analytics module, as described herein.

At a step S310, a feedback module may generate feedback corrective measures to existing rules and/or processes, which feedback corrective measures are calculated to improve performance of one or more aspects of the enterprise system. In embodiments, the feedback corrective measures may comprise recommendations of modified behavioral data values to adjust one or more processes, decisions, and/or rules of the enterprise system.

Following the path to the right, following the categorization of enterprise system components at step S302, at a step S312, an actualization module may determine actualization scores for one or more cognitive framework categories of the enterprise system. Actualization scores may identify the degree to which a component or category of components is performing at its potential. Actualization scores may be based at least in part on values that weight each component or category of components based on their relative importance to the enterprise system. Determining category scores may comprise first determining actualization scores for each component or component type within the category.

At a step S314, an enterprise architecture analysis module may generate an electronic assessment of potential improvements to the enterprise system (e.g., improvements to one or more components of the enterprise system, such as hardware, processes, and/or rules), which potential improvements are calculated to reach a target actualization (e.g., a target performance level, which may be measured in relation to a calculated potential performance level). The electronic assessment of potential improvements may comprise an electronic enterprise architecture blue print that identifies areas in the enterprise system where performance may be improved.

FIG. 3B is a flow chart of an exemplary process for performance analysis of an enterprise system in accordance with exemplary embodiments of the present invention. Such a process may be performed by a performance analysis computer system (e.g., running one or more modules, as described with respect to FIG. 1B).

In a step S322, one or more computers may be used to associate a plurality of component data comprising component information of an enterprise system with respective category data comprising category information of a cognitive analysis framework. In embodiments, the one or more computers may first identify the plurality of components of the enterprise system (e.g., system processes, rules, structures, inputs, and/or outputs, to name a few), and store component data for each component. The category information may include a user activity category information associated with user interactions in the enterprise system, a communication category information associated with communications produced by the enterprise system, an action category information associated with actions taken by the enterprise system, a knowledge category information associated with data stored by the enterprise system, a sensory category information associated with external interfaces of the enterprise system; and a learning category information associated with feedback analytics of the enterprise system. Each category data record may comprise one such category information that is associated with each enterprise system component data record.

In a step S324, the one or more computers may store (e.g., in a database) the associated respective category data for each of the plurality of component data.

In a step S326, the one or more computers may be used to assign a respective weight value for each of the plurality of component data. The weight value for each component may identify a relative importance of the respective component to the enterprise system.

In a step S328, the one or more computers may store a first ontology comprising workflow definitions. In embodiments, the one or more computers may be used to generate the first ontology.

In a step S330, the one or more computers may store a second ontology comprising business rule definitions. In embodiments, the one or more computers may be used to generate the second ontology. In embodiments, the second ontology may be designed to integrate with the first ontology. In embodiments, the second ontology and the first ontology may be parts of the same ontology.

In a step S332, the one or more computers may store a third ontology comprising operational data definitions. The third ontology may be used to describe and/or store operational data, which may be point-in-time operational data associated with a state of the enterprise system at a particular time and/or resultant operational data associated with a completed state of the enterprise system (e.g., after one or more processes are performed). In embodiments, the one or more computers may be used to generate the third ontology. In embodiments, the third ontology may integrate with the first ontology, the second ontology, and/or other ontologies, which may facilitate analysis of different data types. In embodiments, the one or more computers may be used to update an ontology, e.g., to reflect changes in data types and/or changes in data available from the enterprise system. In embodiments, one or more other ontologies may be stored and may be associated with other data types.

In a step S334, the one or more computers may obtain runtime behavioral data comprising performed workflow data specified in the first ontology and implicated business rule data specified in the second ontology. The one or more computers may also obtain point-in-time operational data associated with a runtime behavior of the enterprise system and associated with a timestamp and specified in the third ontology. Performed workflow data may identify workflows that were executed, which may include identifications of particular steps that were executed, execution times (e.g., how long a step or a process took), inputs, and/or outputs. Implicated business rule data may identify enterprise system rules that were triggered, and/or decision points reached. Point-in-time operational data may be operational data from the enterprise system at a particular time (e.g., indicated by an associated timestamp). The point-in-time operational data may describe a state (e.g., an instantaneous state) of the enterprise system at the particular time. The one or more computers may first obtain data, e.g., by retrieving the data (e.g., from one or more databases, devices, or systems) and/or by receiving the data. Then, the one or more computers may specify such data in a respective ontology. Then, the one or more computers may store the data specified in the respective ontology.

In a step S336, the one or more computers may obtain resultant operational data specified in the third ontology. Such data may describe the outcomes of decisions at decision points, the operational values at that point in time, and/or enterprise system outputs. The one or more computers may obtain the resultant operational data, specify it in the third ontology (e.g., convert it to and/or map it to the third ontology), and then store the resultant operational data specified in the third ontology.

In a step S338, the one or more computers may be used to analyze at least the runtime behavioral data, the point-in-time operational data, the resultant operational data, and the respective weight values to determine one or more first data patterns associated with a first event. For example, a first event may be a denial of an insurance claim. In embodiments, the determination of the one or more first data patterns may be based at least in part upon the category data. In embodiments, the one or more computers may determine first data patterns for each category information present in an enterprise system.

In a step S340, the one or more computers may be used to determine one or more modified behavioral data records (e.g., modified data values and/or modified parameters for the enterprise system) calculated to modify a recurrence of the first event. For example, a modified behavioral data record may be calculated to avoid future denial of an insurance claim given the same or similar conditions to a first denial of an insurance claim. Accordingly, the modified behavioral data records may be calculated to enhance performance by improving efficiency, eliminating or reducing delays, and/or decreasing costs, to name a few.

In a step S342, the one or more computers may generate an electronic report identifying the one or more modified behavioral data records. The electronic report may comprise electronic feedback data that may be input into the enterprise system, e.g., to alter its performance. In embodiments, such feedback data may be input into a simulation module for predicting future performance. In embodiments, the electronic report may identify the one or more modified behavioral data records and associated category data. In embodiments, the electronic report may indicate one or more modified behavioral data records for one or more category information.

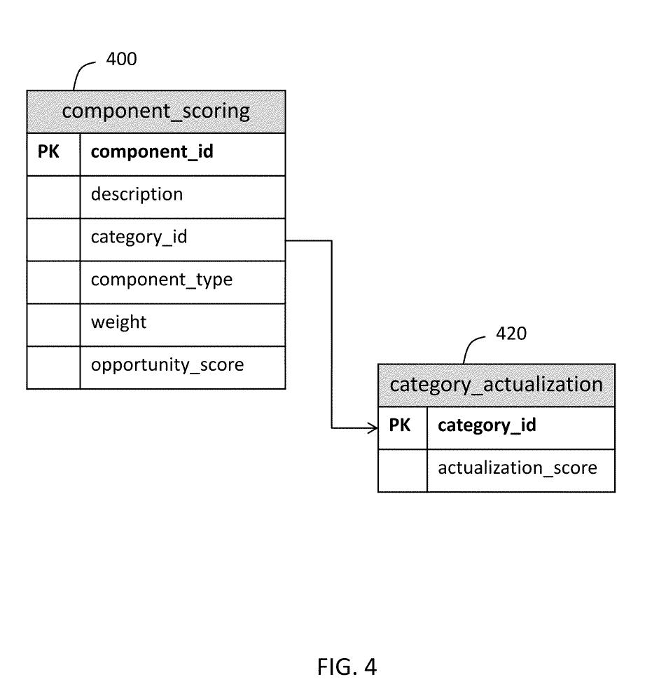

FIG. 4 depicts an exemplary database architecture for cognitive analysis and actualization analysis in accordance with exemplary embodiments of the present invention. The database is illustrated with respect to a relational database architecture, although other database architectures comprising the data discussed herein are possible.

A component_scoring data table 400 may have a component_id as its primary key. The table may include a description of the component, a category_id identifying an associated category for cognitive analysis, a component_type (e.g., a generalized enterprise system component, such as a human interface as opposed to a particular web front-end), a weight (e.g., a value indicating a weight assigned to the component or component type), and/or an opportunity_score (e.g., a value providing a metric of potential performance for the component). The component_scoring table 400 may be operatively connected to a category_acutalization table 420. The category_acutalization table 420 may use the category_id as its primary key, and for each category_id it may store an actualization_score (e.g., a value indicating the degree to which the enterprise system components falling within that category are performing compared to their potential performance levels).

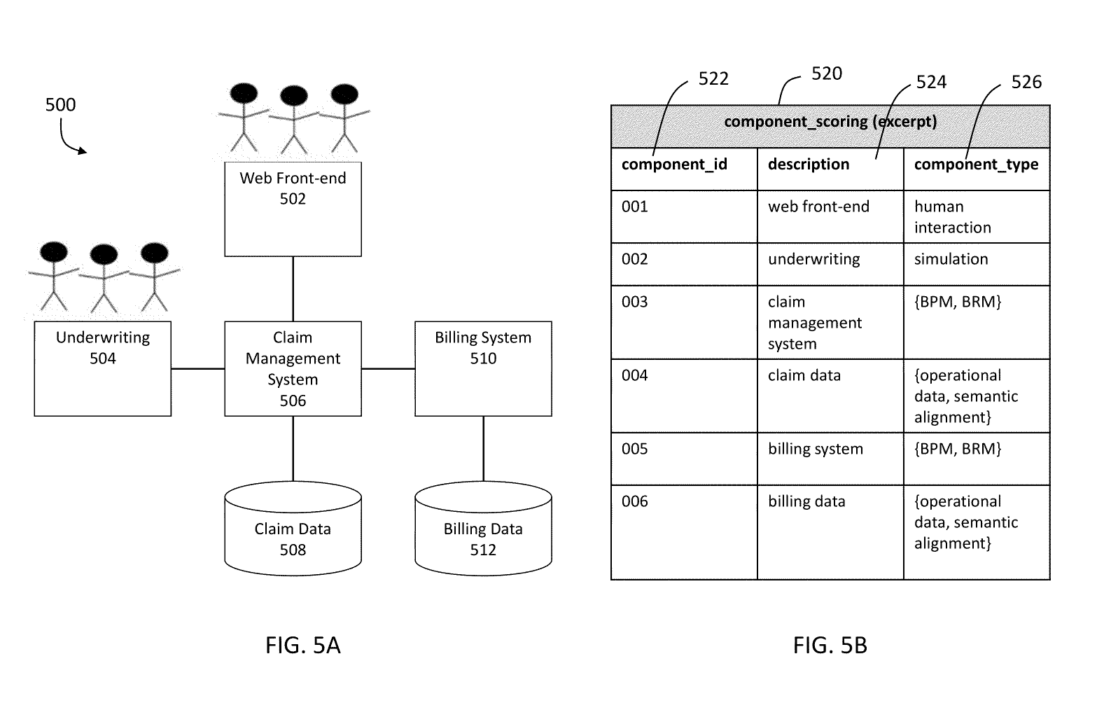

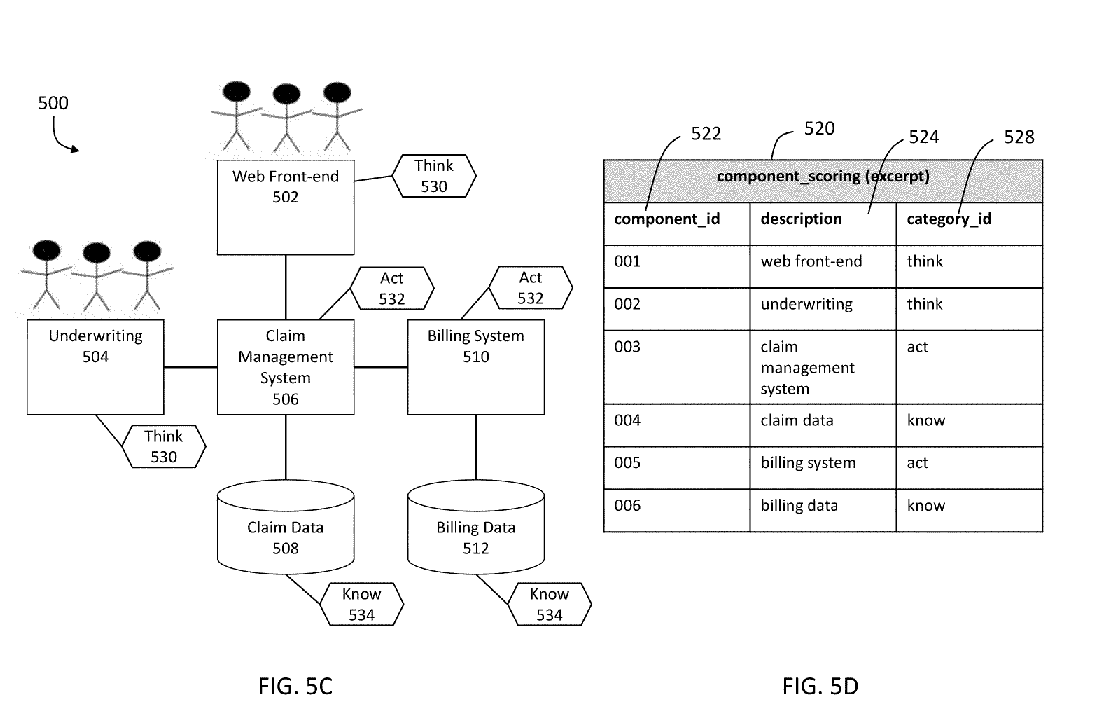

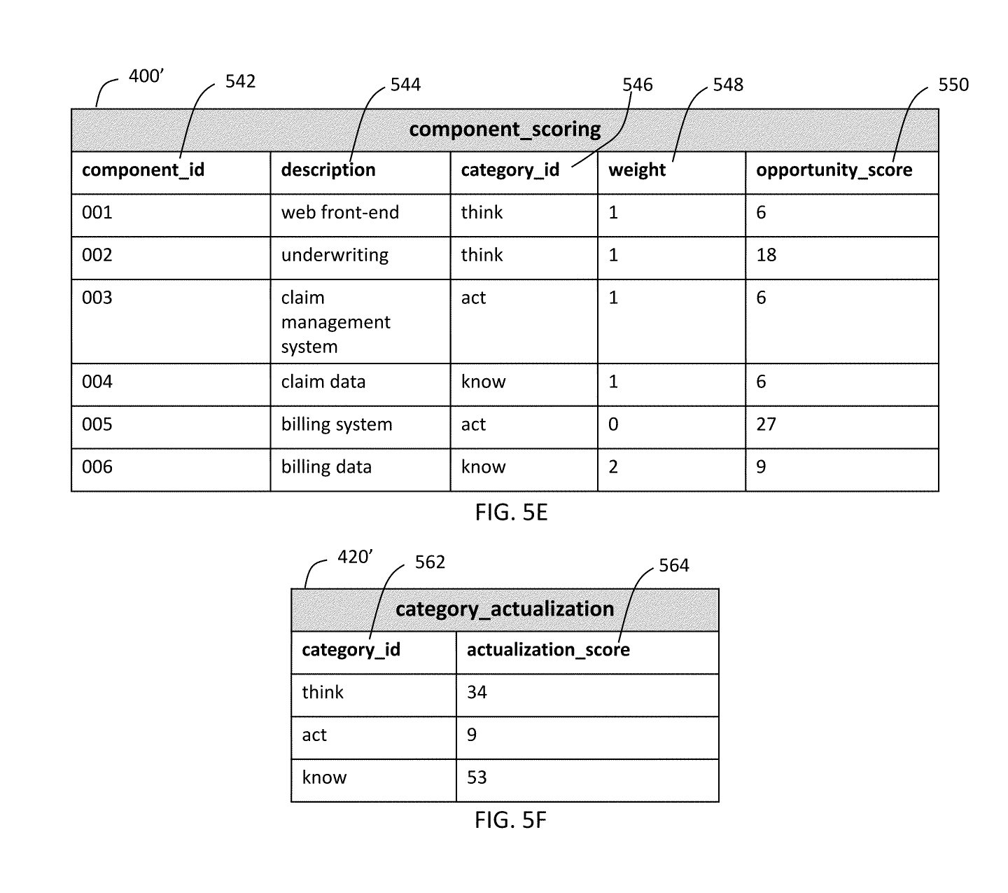

FIGS. 5A-F relate to an actualization analysis of an enterprise system.

FIG. 5A is a schematic diagram of an exemplary enterprise system in accordance with exemplary embodiments of the present invention. The schematic shows components of an enterprise system 500 that processes medical and/or insurance claims. The system may include a web front-end 502 through which one or more users may interact with the system. The system 500 can also include an underwriting system 504, which may be used by one or more users for underwriting the insurance claims. A claim management system 506 may handle claims (e.g., track pending claims and/or process claims), and claim data 508 associated with the insurance claims may be stored in one or more databases. A billing system 510 may handle billing, and billing data 512 may be stored in one or more databases.

FIG. 5B is an exemplary portion of a database storing identified enterprise system components in accordance with exemplary embodiments of the present invention. A component_scoring data table 520 may have a component_id 522 as its primary key, which can be used to query for data related to a particular component. The component_id 522 may be a unique identifier, such as a unique alphanumeric string. A description 524 may describe each component, such as by providing a name for the component or an identification of the component (e.g., a text description, not a database key). In embodiments, one or more component_type 526 may be identified for each enterprise system component and stored in the database. A component_type 526 may be a generic description of a component, such as human interaction, simulation, and/or business process management, to name a few. In embodiments, a plurality of component types may be present for each system component. For example, claim management system 506 may correspond to a first component type, namely, business process management rules, as well as a second component type, namely, business rule management definitions.

FIG. 5C is a schematic diagram of an exemplary enterprise system with associated cognitive analysis category data in accordance with exemplary embodiments of the present invention. For each component of the enterprise system 500, a category is identified. For example, web front-end 502 and underwriting 504 are both associated with a think category 530, which may be a category for user interaction with the enterprise system. The claim management system 506 and billing system 510 are both associated with an action category 532 because both systems comprise rules governing actions by aspects of the enterprise system 500. The claim data 508 and billing data 512 are both associated with a knowledge category 534, since they both entail the storage of information used by the enterprise system 500.

FIG. 5D is an exemplary portion of a database storing category data for enterprise system components in accordance with exemplary embodiments of the present invention. An excerpt of the component_scoring data table 520 is shown. For each component a category_id 528 identifies a category associated with the component. This database reflects the portion of the cognitive analysis that identified categories for each component of the enterprise system. In embodiments, a category may be stored in association with each component type instead of each actual component. In embodiments, a category may be identified for each component type of an enterprise system component, where a plurality of component types correspond to an enterprise system component. In embodiments, each component type of a component may comprise a separate entry in the database. In other embodiments, the component types and corresponding data (e.g., corresponding categories) may be stored in arrays in their respective database fields for each component.

FIG. 5E is an exemplary portion of a database storing scoring data for enterprise system components in accordance with exemplary embodiments of the present invention. The component scoring table 400′ can store database records for each identified enterprise system component, indicated by its component_id 542. These records can include the component description 544, category_id 546, weight 548, opportunity_score 550, and/or one or more component_type. Weight 548 may be a value that indicates a relative importance of the component to the enterprise system. The field opportunity_score 550 may comprise a value for each component that indicates a performance potential for that component.

FIG. 5F is an exemplary portion of a database storing actualization data for cognitive analysis categories of an enterprise system in accordance with exemplary embodiments of the present invention. A category_actualization data table 420′ can store actualization scores for each category of an enterprise system. A category_id 562 may provide the primary key to this data table, and for each category indicated by a category_id 562, an actualization_score 564 may be stored. The actualization_score 564 may provide a measure of the degree to which the components of each category of the enterprise system are performing in relation to their computed performance potential.

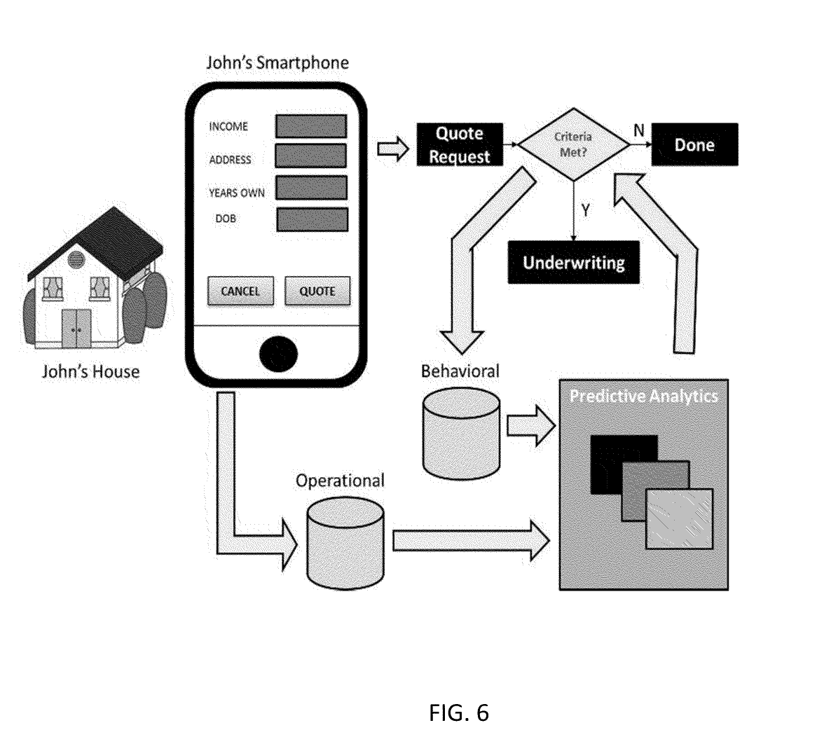

FIG. 6 is a schematic diagram illustrating exemplary implementation of behavioral and operational analytics in accordance with exemplary embodiments of the present invention. In the example, the following facts occur: a person named John bought a house and requires homeowners' insurance. John performs an Internet search for insurance, and the search returns a link to an insurance company comprising and/or operating an enterprise system. John clicks the link, and it brings up a form from the company's insurance quoting system. John fills in his information and submits it.

Upon submission by John of his information using a web-based user interface, John's information is written into a database, which is an example of storage of operational data. The submission of John's information also started a process (e.g., in a BPM/rules system, via computer code stored in memory) whereby the company's system made automated decisions. For example, the company enterprise system may have evaluated proximity of John's house to a coast so as to adjust the risk, or the enterprise system may route the quote request to a certain underwriter based on demographics. This type of information is behavioral data. Behavioral data is stored to collect information about what steps of a process were performed and what decisions were made.

The performance analysis computer system of the present invention can mine both operational data and behavioral data to produce results with greater informational value, such as to show how efficiently a workflow is or determining a pattern (e.g., the enterprise system always makes X decision and a year later pays Y amount, or a relationship between the X decision point and risk being too high on a certain policy type). Once the performance analysis computer system identifies such patterns, that information can be fed back to the enterprise system (or various sub-systems or modules within it) to modify the workflow and the rules.

After operational and behavioral data are mined (e.g., obtained by the performance analysis computer system), they can be input into analytic and data mining tools. Models can then be built for the enterprise system, and performance of the enterprise system can be analyzed, e.g., to determine where opportunities lie, such as reducing costs, improved productivity, and/or other opportunities to enhance performance.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A computer-implemented method for enterprise analysis, comprising:
(a) associating, using one or more computers, a plurality of component data comprising component information of an enterprise system with respective category data comprising category information of a cognitive analysis framework, the category information comprising:
(i) a user activity category information associated with user interactions in the enterprise system;
(ii) a communication category information associated with communications produced by the enterprise system;
(iii) an action category information associated with actions taken by the enterprise system;
(iv) a knowledge category information associated with data stored by the enterprise system;
(v) a sensory category information associated with external interfaces of the enterprise system; and
(vi) a learning category information associated with feedback analytics of the enterprise system;
(b) storing, by the one or more computers, the associated respective category data for each of the plurality of component data;
(c) assigning, using the one or more computers, a respective weight value for each of the plurality of component data;
(d) storing, by the one or more computers, a first ontology comprising workflow definitions;
(e) storing, by the one or more computers, a second ontology comprising business rule definitions;
(f) storing, by the one or more computers, a third ontology comprising operational data definitions;
(g) obtaining, by the one or more computers, runtime behavioral data comprising performed workflow data specified in the first ontology and implicated business rule data specified in the second ontology, and point-in-time operational data associated with a runtime behavior of the enterprise system and associated with a time stamp and specified in the third ontology;
(h) obtaining, by the one or more computers, resultant operational data specified in the third ontology;
(i) analyzing, using the one or more computers, the runtime behavioral data, the point-in-time operational data, the resultant operational data, and the respective weight values to determine one or more first data patterns associated with a first event;
(j) determining, using the one or more computers, one or more modified behavioral data records calculated to modify a recurrence of the first event; and
(k) generating, by the one or more computers, an electronic report identifying the one or more modified behavioral data records.

2. The computer-implemented method of claim 1, wherein the enterprise system includes health care data.

3. The computer-implemented method of claim 1, wherein the enterprise system includes insurance data.

4. The computer-implemented method of claim 1, wherein the first event relates to the occurrence of a productivity inefficiency.

5. The computer-implemented method of claim 1, wherein the first event relates to an insurance claim rejection.

6. The computer-implemented method of claim 1, wherein the electronic report is transmitted to a user electronic device.

7. The computer-implemented method of claim 1, wherein the electronic report comprises an input into a simulation module.

8. The computer-implemented method of claim 1, wherein the electronic report comprises an input into a project management module.

9. The computer-implemented method of claim 1, further comprising the step of providing the electronic report as an input to a feedback loop of the enterprise system.

10. The computer-implemented method of claim 1, wherein the one or more modified behavioral data records relate to modification of one or more workflows.

11. The computer-implemented method of claim 1, wherein the one or more modified behavioral data records relate to modification of one or more business rules.

12. The computer-implemented method of claim 1, wherein the one or more modified behavioral data records are calculated, by the one or more computers, to improve performance of the enterprise system.

13. The computer-implemented method of claim 1, further comprising the step of generating, by the one or more computers, a second electronic report comprising an assessment of the performance of the system, wherein the assessment is based at least in part upon the respective weight values and the runtime behavioral data.

14. The computer-implemented method of claim 13, wherein the assessment comprises an actualization score indicating a value associated with potential performance by the enterprise system.

15. The computer-implemented method of claim 13, wherein the assessment comprises an actualization score for each respective category information indicating a value associated with potential performance by the enterprise system associated with the respective category information.

16. The computer-implemented method of claim 1, further comprising the step of integrating the runtime behavioral data and the operational data using a semantic data integration model.

17. The computer-implemented method of claim 1, wherein the step (g) further comprises:
(i) obtaining, by the one or more computers, the performed workflow data; and
(ii) specifying, using the one or more computers, the performed workflow data in the first ontology.

18. The computer-implemented method of claim 1, wherein the step (g) further comprises:
(i) obtaining, by the one or more computers, the implicated business rule data; and
(ii) specifying, using the one or more computers, the implicated business rule data in the second ontology.

19. The computer-implemented method of claim 1, wherein the step (g) further comprises:
(i) obtaining, by the one or more computers, the point-in-time operational data; and
(ii) specifying, using the one or more computers, the point-in-time operational data in the third ontology.

20. The computer-implemented method of claim 1, wherein the step (g) further comprises:
(i) obtaining, by the one or more computers, the resultant operational data; and
(ii) specifying, using the one or more computers, the resultant operational data in the third ontology.
